(19) United States
(12) Patent Application Publication
(10) Pub. No.: US 2023/0224383 A1
(43) Pub. Date: Jul. 13, 2023

(54) EXTENDED REALITY (XR) TRAFFIC HANDLING

(71) Applicant: MediaTek Singapore Pte. Ltd., Singapore (SG)

(72) Inventors: Xuelong WANG, Beijing (CN); Xiaonan ZHANG, Beijing (CN)

(73) Assignee: MediaTek Singapore Pte. Ltd., Singapore (SG)

(21) Appl. No.: 18/151,720

(22) Filed: Jan. 9, 2023

(30) Foreign Application Priority Data
Jan. 10, 2022 (WO) PCT/CN2022/071036
Jan. 10, 2022 (WO) PCT/CN2022/071038
Dec. 20, 2022 (CN) 202211639711.4

(51) Int. Cl. H04L 69/22; H04L 5/00

(52) U.S. Cl. CPC H04L 69/22; H04L 5/0048

(57) ABSTRACT

A method for application-specific traffic handling is provided. A service data unit (SDU) can be received at a radio protocol layer in a radio access network (RAN) protocol stack. The SDU carries application data that is generated from an application layer and passes through multiple protocol layers existing between the application layer and the radio protocol layer. At the radio protocol layer, the SDU is inspected to obtain characteristic information from one or more protocol headers corresponding to one or more protocol layers among the multiple protocol layers. The characteristic information indicates characteristics of the application data. At the radio protocol layer, the SDU is classified into one of multiple classes based on the characteristic information obtained from the one or more protocol headers. At the radio protocol layer, the SDU is processed according to which one of the multiple classes the SDU is classified into.

### INCORPORATION BY REFERENCE

This present application claims the benefit of Chinese Patent Application No. International Application No. 202211639711.4, filed Dec. 20, 2022, which claims the benefit of PCT/CN2022/071038, filed on Jan. 10, 2022, and International Application No. PCT/CN2022/071036, filed on Jan. 10, 2022. The disclosures of all the prior applications are incorporated herein by reference in their entirety.

### TECHNICAL FIELD

The present disclosure relates to wireless communications and specifically relates to traffic handling in a wireless network based on application-specific information.

### BACKGROUND

Extended reality (XR) is an umbrella term for applications and services related to virtual reality (VR), augmented reality (AR), and cloud gaming (CG). XR does not fit well into the existing classification of fifth-generation (5G) applications and services, typically divided into enhanced mobile broadband (eMBB), ultra-reliable low latency communications (URLLC), and massive machine-type communications (eMTC). Efficient support for XR services imposes new challenges for existing and future wireless networks.

### SUMMARY

Aspects of the disclosure provide a method for application-specific traffic handling. The method can include receiving a service data unit (SDU) at a radio protocol layer in a radio access network (RAN) protocol stack. The SDU carries application data that is generated from an application layer and passes through multiple protocol layers existing between the application layer and the radio protocol layer. At the radio protocol layer, the SDU is inspected to obtain characteristic information from one or more protocol headers corresponding to one or more protocol layers among the multiple protocol layers. The characteristic information indicates characteristics of the application data. At the radio protocol layer, the SDU is classified into one of multiple classes based on the characteristic information obtained from the one or more protocol headers. At the radio protocol layer, the SDU is processed according to which one of the multiple classes the SDU is classified into.

In an embodiment, the radio protocol layer is a service data adaption protocol (SDAP) layer in the RAN protocol stack. The SDU is an internet protocol (IP) packet. The processing includes mapping the IP packet to a data radio bearer (DRB) according to which one of the multiple classes the IP packet is classified into, wherein IP packets belonging to different classes are mapped to different DRBs.

In an embodiment, the radio protocol layer is a packet data convergence protocol (PDCP) layer in the RAN protocol stack, and the SDU is an PDCP SDU. The processing includes mapping the PDCP SDU to a radio link control (RLC) entity according to which one of the multiple classes the PDCP SDU is classified into, wherein PDCP SDUs belonging to a same DRB but different classes are mapped to different RLC entities.

In an embodiment, the radio protocol layer is a PDCP layer in the RAN protocol stack, and the SDU is an PDCP SDU. The processing includes assigning to the PDCP SDU a PDCP discard timer having a time interval determined according to which one of the multiple classes the PDCP SDU is classified into, wherein PDCP SDUs belonging to different classes are assigned with PDCP discard timers having different time intervals. In an example, PDCP SDUs that are associated with a same application data unit (ADU) are discarded together. In an example, PDCP SDUs that are associated with a same application data unit (ADU) are associated with a same discard timer.

In an embodiment, the radio protocol layer is a PDCP layer in the RAN protocol stack, the SDU is a first PDCP SDU, and the processing includes prioritizing delivery of the first PDCP SDU of the one of the multiple classes over a second PDCP SDU, the second PDCP SDU being classified into a class having a lower priority than the one of the multiple classes.

In an embodiment, the radio protocol layer is an RLC layer in the RAN protocol stack, the SDU is a first RLC SDU, and the processing includes prioritizing delivery of the first RLC SDU of the one of the multiple classes over a second RLC SDU, the second RLC SDU being classified into a class having a lower priority than the one of the multiple classes.

In an embodiment, the classifying includes classifying the SDU into a first class when the characteristic information obtained from the one or more protocol headers indicates the SDU is associated with an I-frame in a video sequence, and classifying the SDU into a second class when the characteristic information obtained from the one or more protocol headers indicates the SDU is associated with a P frame or a B frame in the video sequence. The first class has a higher priority than the second class.

In an embodiment, the multiple protocol layers include an IP layer and a real-time transport protocol (RTP) layer. The inspecting includes inspecting, at the radio protocol layer, an IP header of the IP layer in the SDU to obtain first characteristic information and, when the first characteristic information indicates the SDU is associated with a specific type of traffic, proceeding to inspect an RTP header of the RTP layer to obtain second characteristic information. In an example, the first characteristic information is indicated by a differentiated services code point (DSCP) in the IP header, and the second characteristic information is indicated by an RTP payload type value in the RTP header.

Aspects of the disclosure provide an apparatus including circuitry. The circuitry is configured to receive an SDU at a radio protocol layer in a RAN protocol stack. The SDU carries application data that is generated from an application layer and passes through multiple protocol layers existing between the application layer and the radio protocol layer. At the radio protocol layer, the SDU is inspected to obtain characteristic information from one or more protocol headers corresponding to one or more protocol layers among the multiple protocol layers. The characteristic information indicates characteristics of the application data. At the radio protocol layer, the SDU is classified into one of multiple classes based on the characteristic information obtained from the one or more protocol headers. At the radio protocol layer, the SDU is processed according to which one of the multiple classes the SDU is classified into.

Aspects of the disclosure provide a non-transitory computer-readable medium storing instructions. The instructions, when executed by a processor, cause a processor to perform the above method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a protocol stack 100 for handling extender reality (XR) traffic according to embodiments of the disclosure.

FIG. 2 shows an example of the transmission of application data units (ADUs) in an IP traffic flow 201 according to embodiments of the disclosure.

FIG. 3 shows an example of XR frame processing process across multiple protocol layers.

FIG. 4 shows an example of internet protocol (IP-based packet classification at a user plane function (UPF) 403 for downlink XR traffic according to embodiments of the disclosure.

FIG. 5 shows an example of service-data adaptation protocol (SDAP)-based packet classification at a base station (BS) 502 for downlink XR traffic according to embodiments of the disclosure.

FIG. 6 shows an example of packet data convergence protocol (PDCP)-based packet classification at a BS 602 for downlink XR traffic according to embodiments of the disclosure.

FIG. 7 shows a PDCP packet discarding process 700 based on a unified PDCP discard timer configuration.

FIG. 8 shows a PDCP packet discarding process 800 according to embodiments of the disclosure.

FIG. 9 shows a PDCP packet delivery process 900 according to embodiments of the disclosure.

FIG. 10 shows an SDAP-based XR packet inspection and classification process 1040 according to embodiments of the disclosure.

FIG. 11 shows an SDAP-based XR packet inspection and classification process 1100 according to embodiments of the disclosure.

FIG. 12 shows a PDCP-layer XR traffic handling process 1200 according to embodiments of the disclosure.

FIG. 13 shows an radio-link control (RLC) layer XR traffic handling process 1300 according to embodiments of the disclosure.

FIG. 14 shows a medium access control (MAC) layer XR traffic handling process 1400 according to embodiments of the disclosure.

FIG. 15 shows an XR traffic handling process 1500 according to embodiments of the disclosure.

FIG. 16 shows a packet inspection and classification process 1600 according to embodiments of the disclosure.

FIG. 17 shows an exemplary apparatus 1700 according to embodiments of the disclosure.

### DETAILED DESCRIPTION OF EMBODIMENTS

Extended reality (XR) traffic from XR applications can have special traffic characteristics compared with traditional applications. For example, a set of data packets can carry the payload of one unit of information generated at the application level (e.g., a video frame or a video slice from an encoder of an XR service). The whole set of data packets is needed by the application layer (e.g., a decoder) to use the corresponding unit of information. (The unit of information can be referred to as an application data unit (ADU).) The ADU can be a data burst or a PDU set, where appropriate. Those interrelated data packets need to be identified and handled collectively when being transmitted through a wireless network. For another example, data packets carrying the payloads of different units of information (e.g., I-frame versus P-frame) may have different importance. Those different groups of data packets can be identified and treated differently during transmission. The existing radio access networks (RANs) (e.g., Long Term Evolution (LTE) RAN or New Radio (NR) RAN) are typically designed to be service-agnostic (or application-agnostic), which limits the support a RAN can provide for XR traffic.

The present disclosure provides techniques and methods to enable a RAN to be XR-aware and thus to perform XR-specific traffic handling. For example, radio access protocol layers (or referred to as radio access layers) in a RAN protocol stack can exploit information from an application layer (for example, indicated by a header of an upper transport protocol layer) to perform application-specific traffic handling.

In some embodiments, a service data adaption protocol (SDAP) layer is configured to inspect header information of upper protocol layers carried in internet protocol (IP) packets and accordingly classify IP packets into different classes, such as a critical IP packet class and a non-critical IP packet class. Based on the inspection and classification results, IP packets from a quality of service (QoS) flow can be mapped to different data radio bearers (DRBs). In some embodiments, SDAP protocol data units (PDUs) of different DRBs can be associated with discard timers having different time intervals.

In some embodiments, a packet data convergence protocol (PDCP) layer can inspect header information of upper protocol layers carried in PDCP SDUs and accordingly classify the PDCP SDUs into different classes, such as critical data units and non-critical data units. A critical data unit can be associated with a discard timer having a longer time interval than a discard timer associated with a non-critical data unit. Also, the PDCP layer may identify PDCP SDUs belonging to a same ADU and associate a same timer to these data units or a set of coordinated timers to these data units.

In some embodiments, based on the inspection and classification results, the PDCP layer may prioritize the delivery of critical data units over non-critical data units from the PDCP layer to a radio-link control (RLC) layer. Alternatively or additionally, the RLC layer can prioritize the delivery of critical data units over non-critical data units.

The application-specific traffic handling mechanisms disclosed herein are not limited to XR applications or XR traffic. The mechanisms can be applied to any applications where application layer information awareness is helpful to improve traffic handling in RAN.

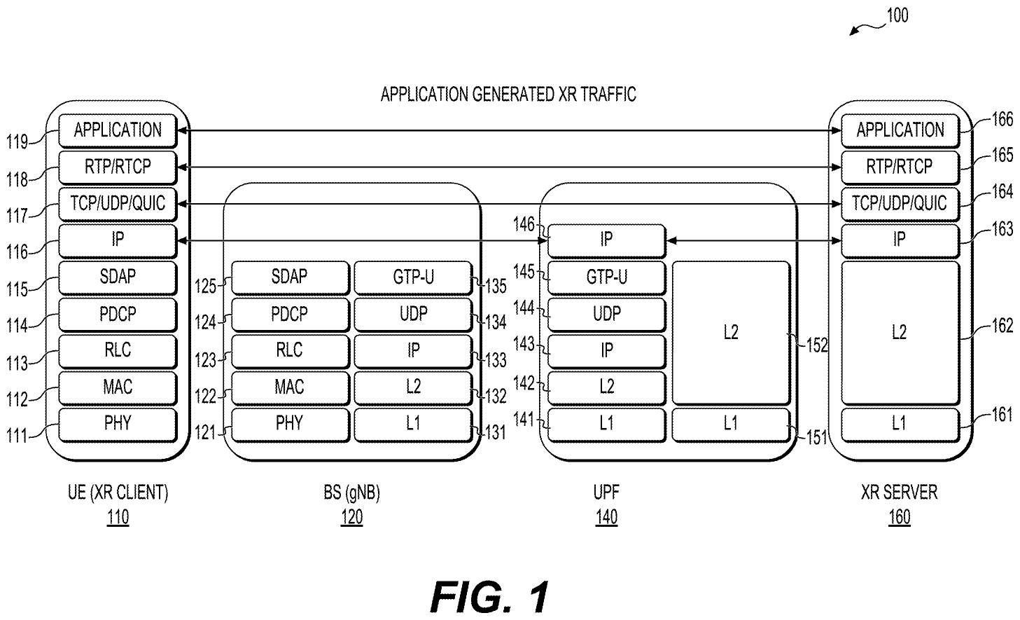

FIG. 1 shows a protocol stack 100 for handling XR traffic according to embodiments of the disclosure. The protocol stack 100 includes protocol stacks configured at several network nodes in a network: a user equipment (UE) 110, a base station (BS) 120 (e.g., a gNB), a user plane function (UPF) 140, and an XR server 160. The UE 110 can be configured with a physical layer (PHY) 111, a medium access control layer (MAC) 112, an RLC layer 113, a PDCP layer 114, a SDAP layer 115, an IP layer 116, a network transport layer 117 (e.g., transmission control protocol (TCP), user datagram protocol (UDP), or QUIC), a media streaming transport protocol layer 118 (e.g., real-time transport protocol (RTP) and RTP control protocol (RTCP)), and an application layer 119. The UE 110 can function as an XR client. In various embodiments, the UE can be a computer, a mobile phone, a wearable device, a head-mounted device, a device installed in a vehicle, or the like.

The BS 120 at the side interfacing the UE 110 can be configured with a PHY layer 121, a MAC layer 122, an RLC layer 123, a PDCP layer 124, and an SDAP layer 125. The BS 120 at the side interfacing the UPF 140 can be configured with a physical layer (L1) 131, a data link layer (L2) 132, an IP layer 133, a UDP layer 134, a general packet radio service (GPRS) tunneling protocol—user plane (GTP-U) layer 135.

The UPF 140 at the side interfacing the BS 120 can be configured with an L1 layer 141, an L2 layer 142, an IP layer 143, a UDP layer 144, a GTP-U layer 145, and an IP layer 146. The UPF 140 at the side interfacing the XR server 160 can be configured with an L1 layer 151 and an L2 layer 152. In some embodiments, the UE 110, the BS 120, and the UPF 140 can operate with each other according to related standards developed by the 3rd generation partnership project (3GPP).

The XR server 160 can be configured with an L1 layer 161, an L2 layer 162, an IP layer 163, a network transport layer 164 (e.g., TCP, UDP, or QUIC), a media streaming transport protocol layer 165 (e.g., RTP and RTCP), and an application layer 166.

At the application layer (corresponding to the application layers 119 and 166), XR applications can be supported by existing video coding standards (e.g., High-Efficiency Video Coding (HEVC) and Advance Video Coding (AVC)). However, XR-specific encoder and decoder are subject to further work, for example, by MPEG-I or other standardization organizations. Also, other technical components besides existing MPEG specifications may be provided in order to create interoperable immersive experiences for XR applications. In some embodiments, an XR encoder (or decoder) can be based on H.264 and/or H.265.

As shown, application generated XR traffic (encoded video or other control information) can be transported by the media streaming transport protocol layer (RTP and RTCP) (corresponding to the media streaming transport protocol layers 118 and 165). In other examples, the media streaming transport protocol layer can be based on the real-time messaging protocol (RTMP), HTTP live streaming (HLS), web real-time communication (WebRTC), or the like. These streaming transport protocol layers can have different performance (e.g., streaming latency). As shown, the network transport layer for XR traffic (corresponding to the network transport layers 117 and 164) can be based on UDP, TCP, QUIC, or the like. In some embodiments, a combination of RTP and UDP are used as the streaming transport protocol layer and network transport protocol layer.

As shown, at the IP layers 116, 146, and 163, IP protocol is used as the routing protocol layer for the transmission of XR traffic within the network. From air interface perspective, the radio protocol layers (111-115 and 121-125) at the UE 110 and BS 120 handle IP packets transmission over a radio interface between the UE 110 and BS 120.

In the case of UDP/IP, IP packet fragmentation at the IP layer is not applied for a video stream in some embodiments. The RTP layer or a network adaptation layer (NAL) (e.g., H.264 or H.265) can perform packet fragmentation in order to match a maximum transmission unit (MTU) size at a lower layer.

RTP and an XR traffic encoder typically support a large packet size. UDP can support up to around 65 K packet size (such 65118 bytes). IP can support up to 65 K packet size. IP supports IP packet fragmentation in case the MTU required by layer-2 (i.e. link layer) is smaller than IP packet. For example, if the IP packet is 10 K, but the MTU size is 1 K, then IP can segment that packet into 10 IP packets before routing. IP packet fragmentation is not preferred since it is a best-effort transmission for the segments. IPv6 forbids fragmentation at intermediate nodes.

During media stream coding in an encoder and packet assembly in the media streaming transport protocol layer (e.g., RTP layer), various packet information may be included within protocol headers to indicate attributes of the application data payload. By inspecting this information, a lower layer (e.g., IP, SDAP, PDCP, etc.) can be aware of attributes of application data carried in a particular data packet. The lower layer can accordingly apply packet-specific handling strategies.

Examples of the said information to express the attributes of a particular data packet can include: (1) the packet belongs to which media streaming picture slice; (2) the packet belongs to which application data unit (ADU); (3) the packet belongs to which encoding layer (e.g. base layer or enhanced layer for better quality viewing); (4) the packet belongs to which media streaming frame (or picture); (5) the packet belongs to which type of media streaming frame (e.g. I-frame or P-frame); (6) the packet belongs to critical data or non-critical data; (7) the packet delay budget for the packet; (8) priority of the packet; (9) the packet is new transmission or retransmission at media streaming transport protocol layer or application layer; (10) the packet is a redundant packet or a non-redundant transmission; (11) the packet is a control packet or a data streaming packet from media streaming transport protocol layer; (12) the reliability requirement of the packet; and (13) the packet belongs to which media traffic type (e.g. XR traffic).

In some examples, a wireless network (e.g., a 5G system (5GS)) exploits differentiated services (DiffServ) and differentiated services code point (DSCP) at IP layer to do packet marking and to associate a given packet to a given QoS flow. For example, DiffServ uses a 6-bit DSCP in an 8-bit differentiated services field (DS field) in the IP header for packet classification purposes. The 6 DSCP bits can be used to map the traffic carried by IP packets to the traffic expressed by a 5G QoS identifier (5QI). The mapping can be based on a fixed mapping table between DSCP and 5QI as defined, for example, by an operator. These DSCP bits are visible at the network layer. From a service granularity perspective, DiffServ is a coarse-grained mechanism for traffic handling due to limited number of DSCP bits.

The DSCP scheme can be extended and exploited for purpose of XR awareness. In some examples, DSCP values can be configured to indicate specific XR media streams from an application layer. A radio access protocol layer in a RAN can accordingly inspect the DSCP value in an IP header and accordingly determine a class for a specific IP packet.

In some embodiments, data units corresponding to a specific protocol layer are inspected and accordingly classified into one of multiple classes. In some examples, the data units are classified into critical data units and non-critical data units. A data unit is used as a general term to refer to a structured bit sequence handled or produced in a specific protocol layer in this disclosure. For example, a data unit can be used to refer to an SDU, a PDU, a packet, a datagram, and the like for discussing various data packet inspection and classification mechanisms taking place at different protocol layers. Data unit and packet may be used interchangeably in this disclosure.

In some embodiments, critical packets can be defined as packets of high importance and the reception of these packets is prioritized compared with non-critical packets. Critical packets may have more stringent transmission requirements in terms of quality, reliability, packet error rate, packet delay budget, or the like. For example, specific to an XR video stream, critical packets can be an I-frame, and normal packets (i.e., non-critical packets) can be a P-frame (or a B-frame). Specific to an XR application, critical packets can be control-related packets, and the normal packets (i.e., non-critical packets) can be media data.

In some embodiments, data units at a protocol layer can be inspected and identified as part of an ADU. Data units belonging to a same ADU can thus be handled collectively. For example, different frames, different slices, or different application data units at an application layer can be associated with a different RTP payload type (PT) at an RTP layer. An RTP payload type at an RTP header may provide the information that this packet belongs to a specific ADU, such as a particular frame (e.g., a particular I-frame or P-frame for a video stream) or a particular slice. By inspecting the RTP payload type (carried in a PT field of an RTP header), a lower layer (e.g., IP, SDAP, PDCP, and the like) can classify an RTP packet (or a data unit carrying this RTP packet) based on which type of ADU the RTP packet belongs to. The lower layer can also determine the ADU which the RTP packet (or the data unit carrying this RTP packet) is associated with. Knowing the association of data units with a PDU helps a low layer to do coordinated processing for a group of packets, such as collectively packet dropping, packet prioritization and/or packet preemption.

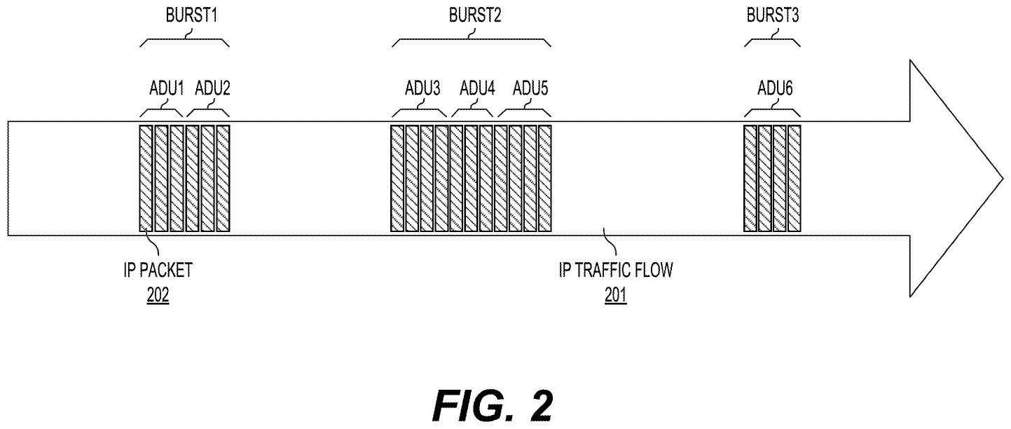

FIG. 2 shows an example of the transmission of ADUs in an IP traffic flow 201 according to embodiments of the disclosure. The IP traffic flow 201 can include a sequence of IP packet bursts: Burst 1, Burst 2, and Burst 3. Each burst can include a group of IP packets 202 belonging to one or different ADUs. As shown, the group of IP packets in Burst 1 belong to two ADUs: ADU 1 and ADU 2. The group of IP packets in Burst 2 belong to three ADUs: ADU 3, ADU 4, and ADU 5. The group of IP packets in Burst 3 belong to a same ADU: ADU 6. In some examples, downlink or uplink XR traffic of XR applications (including cloud gaming) typically includes encoded video or scene information. These XR applications may require a certain minimum granularity of application data to be available on a client side or server side before the next level of processing can start. The minimum granularity of traffic consumption will require a certain minimum set of IP packets available before the next level of processing can start. This minimum granularity of information that a given application requires can be considered or handled as an ADU.

XR traffic can have different QoS requirements than traffic of other applications due to the specific traffic characteristics of XR traffic. For example, not all packets in an XR traffic are equally important, and different packets may have different QoS requirements. Not all bits within an ADU are equally significant, and different packet delay budgets (PDBs) may be assigned for packets within one ADU. ADU-based error rate (AER) (the percentage of ADUs in error in a specified measurement window) can be defined as a QoS parameter. Different data rates, PDBs, packet error rates (PER), AER, and the like, can be specified for different streams from one XR traffic.

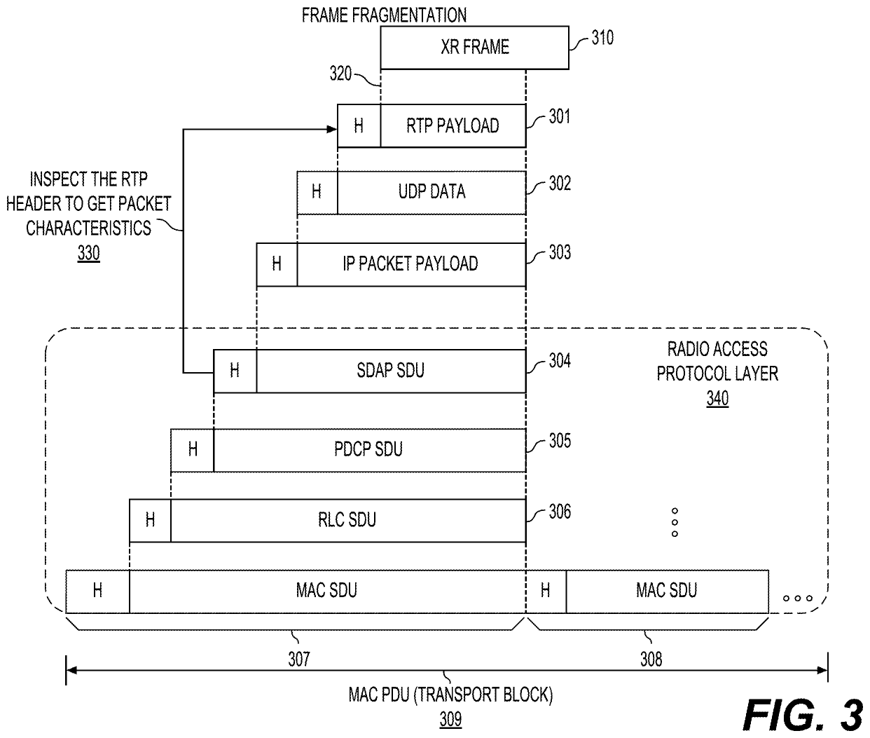

FIG. 3 shows an example of XR frame processing process across multiple protocol layers. As shown, by performing a frame fragmentation 320 at an application layer and/or an RTP layer, an XR frame 310 is segmented into multiple portions. One portion is included in a payload of an RTP packet 301. Typically, frame fragmentation is performed at a real-time transport layer (e.g., RTP layer) together with an encoder (e.g., a network adaptation layer of H.265). Usually, IP fragmentation at an IP layer is not enabled in most cases. XR payload type information and other extra information can be included in a header of an application transport layer. The information carried in the header enables packet awareness (XR awareness) at a radio access layer and/or a core network, for example, as defined in 3GPP standards.

In the FIG. 3 example, a payload type field in a header (denoted by H) of the RTP packet 301 can be used to indicate, on a per-packet basis, which payload format is used. The binding between a payload type number and a payload format and its configuration is dynamically bound and RTP session specific. The configuration information can be bound to a payload type value by out-of-band signaling. The payload type information and other information in an RTP packet header, sometimes in combination with header information of other protocol layers, can provide packet (or traffic) characteristics information useful for a radio access layer in a RAN to perform packet inspection and classification.

For example, the RTP header itself or in combination with header information of other protocol layers can indicate that the RTP payload carries a segment of the XR frame 310 and whether the XR frame 310 is an I-frame or P-frame (or B-frame). Based on the information, a radio access layer can determine which ADU a data unit (associated with the RTP packet 301) belongs to and how important the data unit is (critical or non-critical). As shown in FIG. 3, an SDAP layer can perform inspection 330 of the RTP header (denoted by H) to be aware of packet characteristics of the RTP packet 301. The packet characteristics represent characteristics of the application data carried in the RTP packet 301.

Crossing the protocol layers shown in FIG. 3, the RTP packet 301 is encapsulated into a UDP packet 302. The UDP packet 302 is encapsulated into an IP packet 303. Entering a radio access protocol layer 340, the IP packet 303, as an SDAP SDU, is encapsulated into an SDAP packet 304. The SDAP packet 304, as a PDCP SDU (or a SDAP PDU), is encapsulated into a PDCP packet 305. The PDCP packet 305, as an RLC SDU (or a PDCP PDU), is encapsulated into an RLC packet 306. The RLC packet 306, as a MAC SDU (or an RLC PDU), is encapsulated into a MAC packet 307. The MAC packet 307 and another MAC packet 308 are combined into a MAC PDU 309 to form a transport block. The transport block can be processed by a PHY layer and transmitted from a UE to a BS.

In various embodiments, within the protocol stack 100 in FIG. 1, there can be multiple candidate network elements or protocol layers for performing XR-awareness operations (e.g., inspection, classification, class-specific handling). For the downlink, the UPF 140 can be configured to differentiate an XR traffic in terms of different QoS flows. The BS 120 can be configured to perform per-packet handling for one QoS flow based on packet inspection at the SDAP layer 125. Also, at the BS 120, XR-specific packet handling can be performed at the PDCP layer 124, the RLC layer 123, the MAC layer 122, and the PHY layer 121. For the uplink, SDAP or PDCP layer-based XR-specific packet handling can be configured, for example, while disabling IP fragmentation. PHY layer-based XR-specific packet handling can be configured, for example, while RLC segmentation and MAC multiplexing are disabled. Based on packet inspection, multiple priority levels can be used to handle XR packets. For example, multiple priority levels can be defined and mapped to XR traffic types and/or packet types (e.g., I-frame, P-frame, field of view (FOV), and the like).

In some examples, a 5GS can support the transmission of application layer traffic using a default QoS flow in a PDU session. The default QoS flow allows a UE to exchange best-effort traffic with a data network (DN) in the 5GS. In most cases, the 5GS does not establish a dedicated QoS to carry important traffic of an application separately from normal traffic. It may be desirable that XR traffic from an XR application can be provided with multiple QoS flows (including a default QoS flow and one or more dedicated QoS flows). However, there are some practical obstacles to providing such XR QoS flows. For example, there may be a synchronization issue for separate QoS flows (for example classified by a UPF). Also, in case of encryption is applied at an application layer, QoS flow-based XR traffic awareness would be difficult.

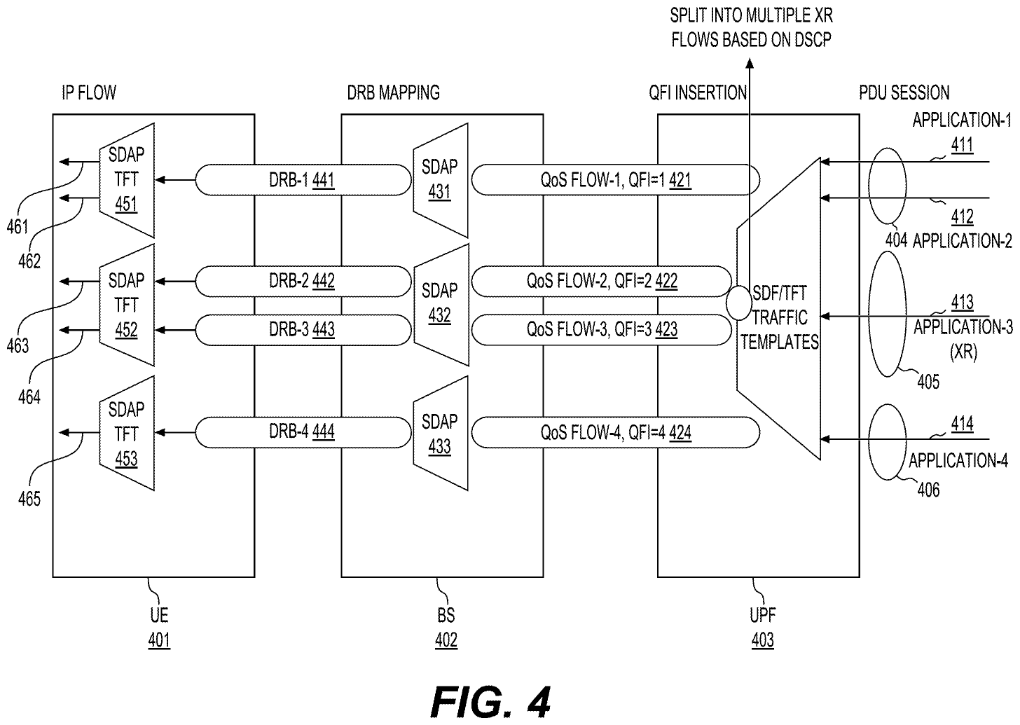

FIG. 4 shows an example of IP-based packet classification at a UPF 403 for downlink XR traffic according to embodiments of the disclosure. As shown, three PDU sessions 404-406 are established between a UE 401 and the UPF 403 across a BS 402. The UPF 403 is configured to classify (filter) IP flows from applications into QoS flows by using a set of service data flow (SDF) templates or traffic flow templates (TFTs). A QoS flow identifier (QFI) is associated with each QoS flow by a QFI insertion operation. The BS 402 is configured to map QoS flows to DRBs at an SDAP layer. The UE 401 is configured to recover IP flows from QoS flows, for example, based on a set of TFTs at an SDAP layer.

As shown, IP flows 411-412 of two applications (application-1 and application-2) belong to the PDU session 404 and are mapped a QoS flow 421. An SDAP entity 431 at the BS 402 maps the QoS flow 421 to a DRB 441. An SDAP entity 451 at the UE 401 separates the QoS flow 421 into two IP flows 461-462. An IP flow 414 of an application (application-4) belongs to the PDU session 406 and is mapped to a QoS flow 424. An SDAP entity 433 at the BS 402 maps the QoS flow 424 to a DRB 444. An SDAP entity 453 at the UE 401 recovers the QoS flow 424 to an IP flow 465.

Application-3 can be an XR application and generate an XR IP flow 413 over the PDU session 405. The UPF 403 can be configured to inspect packets of the XR IP flow 413 and split the XR IP flow 413 into multiple XR QoS flows 422-423. There can be two options for the packet inspection at the UPF 403. In Option 1, the UPF 403 can inspect the RTP payload type (PT field of an RTP header) of each packet and classify different packets to different QoS flows. For example, different payload types can be mapped to different QoS flows. In Option 2, the UPF 403 can inspect a DSCP of the IP layer and classify different packets to different QoS flows. For example, different DSCP values can be mapped to different QoS flows. In the above options, the RTP payload type and IP layer DSCP can be re-designed and/or extended to indicate XR traffic or data characteristics.

In an embodiment, the UE 401 is configured to perform inter-flow synchronization between the SDAP layer and the IP layer to recover the XR IP flow 413. For example, IP packets of the IP flows 463 and 464 can be synchronized to recover the XR IP flow 413.

In some embodiments, the UPF 403 can be configured to mark the XR packets, for example, as critical or non-critical packets, before transmitting the XR packets to the BS 402. The BS 402 can classify packets from an XR QoS flow based on the marks provided by the UPF 403.

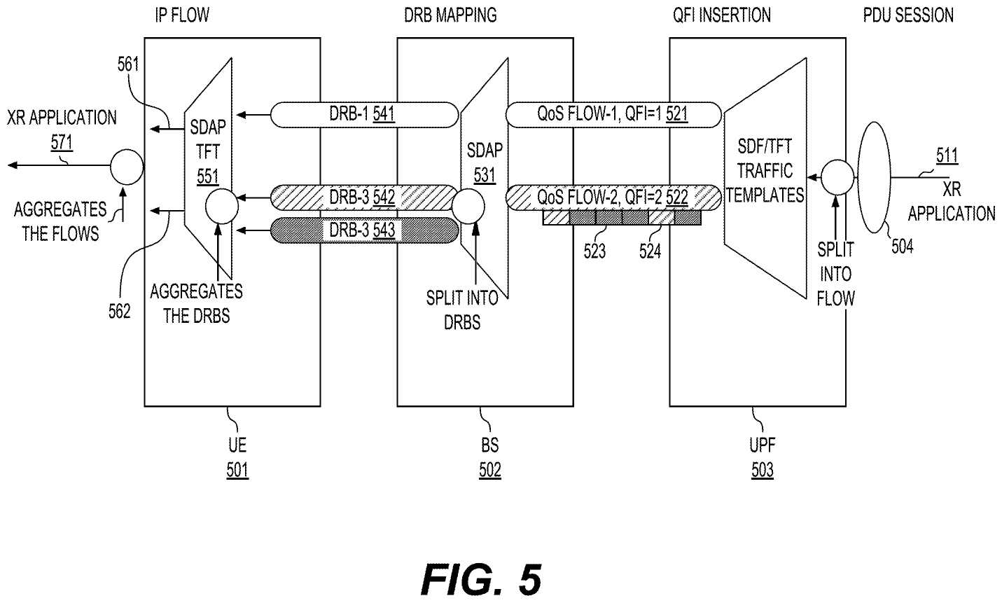

FIG. 5 shows an example of SDAP-based packet classification at a BS 502 for downlink XR traffic according to embodiments of the disclosure. As shown, a PDU session 504 is established between a UE 501 and a UPF 503 across the BS 502. The UPF 503 is configured to classify (filter) IP flows from applications into QoS flows by using a set of service data flow (SDF) or traffic flow template (TFT) traffic templates. A QoS flow identifier (QFI) is associated with each QoS flow by a QFI insertion operation. The BS 502 is configured to map QoS flows to DRBs at an SDAP layer. The UE 501 is configured to recover IP flows from QoS flows, for example, based on a set of TFTs at an SDAP layer.

An XR IP flow 511 is generated from an XR application. The UPF 503 can be configured to split the IP flow 511 into two QoS flows 521-522. In another example, no such split operation is performed at the UPF 503. The QoS flow 522 may carry different types of IP packets. For example, the QoS flow 522 carries critical packets 523 and non-critical packets 524.

At the BS 502, an SDAP entity 531 can split the QoS flow 522 into two flows and map the two flows to two DRBs 542-543. For example, for each IP packet from the QoS flow 522, the SDAP entity 531 can inspect one or more packet headers of transport protocol layers (such as IP, UDP, and/or RTP layers) to know packet characteristics (characteristics of XR data carried in the IP packet). Based on information obtained from the inspection operation, the SDAP entity 531 can classify IP packets from the QoS flow 522 into different classes.

In the FIG. 5 example, the SDAP entity 531 can classify the IP packets into two classes: critical packets 523 and non-critical packets 524. Critical packets 523 are mapped to the DRB 543. Non-critical packets 524 are mapped to the DRB 542. Two PDCP entities can be configured for processing the two DRBs 542-543, respectively. The two PDCP entities can process the two DRBs 542-543 independently. The two PDCP entities serve the same QoS flow 522 and accordingly are associated with each other. At a receiving-side SDAP entity, IP flows corresponding to the two DRBs 542-543 can be aggregated into one IP flow corresponding to the QoS flow 522.

At the BS 502, the SDAP entity 531 also maps the QoS flow to a DRB 541.

At the UE 501, an SDAP entity 551 receives the two IP flows carried in the DRBs 542-543 and combines the two IP flows into one IP flow 562. The SDAP entity 551 also maps the IP flow carried in the DRB 541 to an IP flow 561. The UE 501 can then combine the two IP flows 561-562 to generate an IP flow 571. The IP flow 571 can then be transmitted to an XR application at the UE 501.

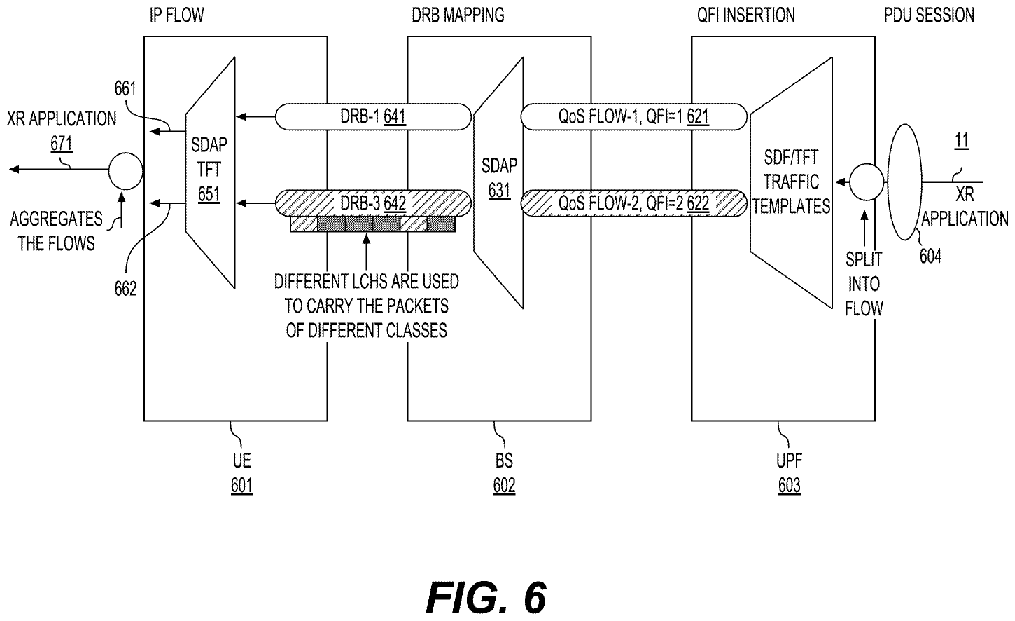

FIG. 6 shows an example of PDCP-based packet classification at a BS 602 for downlink XR traffic according to embodiments of the disclosure. As shown, a PDU session 604 is established between a UE 601 and a UPF 603 across the BS 602. The UPF 603 is configured to classify (filter) IP flows from applications into QoS flows by using a set of service data flow (SDF) or traffic flow template (TFT) traffic templates. A QoS flow identifier (QFI) is associated with each QoS flow by a QFI insertion operation. The BS 602 is configured to map QoS flows to DRBs at an SDAP layer. The UE 601 is configured to recover IP flows from QoS flows, for example, based on a set of TFTs at an SDAP layer.

An XR IP flow 611 is generated from an XR application. The UPF 603 can be configured to split the IP flow 611 into two QoS flows 621-622. In another example, no such split operation is performed at the UPF 603. The QoS flow 622 may carry different types of IP packets. For example, the QoS flow 622 carries critical packets and non-critical packets.

At the BS 602, an SDAP entity 631 can map the QoS flows 621-622 to DRBs 641-642, respectively. A PDCP entity can map the DRB 642 to multiple RLC entities and logical channels (LCHs). For example, the PDCP entity can receive the QoS flow 622 in the DRB 642 (in form of PDCP SDUs or SDAP PDUs) and map the PDCP SDUs in the DRB 642 to multiple RLC entities and further to multiple LCHs.

For example, the PDCP entity can inspect the packet headers of upper transport protocol layers, such as SDAP, IP, UDP, and/or RTP layers, carried in each PDCP SDU. Based on the header information obtained from the inspection operation, the PDCP entity can know the packet characteristics of the respective PDCP SDU or the characteristics of XR data carried in the respective PDCP SDU. Accordingly, the PDCP entity can classify the PDCP SDUs into multiple classes.

In the FIG. 6 example, the PDCP SDUs can be classified into critical data units and non-critical data units. The critical data units can be sent to a first RLC entity (in form of PDCP PDUs) and further to a first LCH. The non-critical data units can be sent to a second RLC entity (in form of PDCP PDUs) and further to a second LCH. The first LCH carrying the critical data units can be associated with a higher priority than the second LCH carrying the non-critical data units in a MAC layer that processes the first and second LCHs.

The first RLC entity and the second RLC entity can operate independently from each other. The first RLC entity (and corresponding first LCH) and the second RLC entity (and corresponding second LCH) can be associated with each other. At a receiving side PDCP entity at the UE 601, PDCP PDUs from different RLC entities (and LCHs) (which correspond to the first and second RLC entities at the BS 602, respectively) can be aggregated into a same PDCP SDU flow. This PDCP SDU flow is further mapped to an IP flow 662 at the UE 601 by an SDAP entity 651.

At the UE 601, the SDAP entity 651 also maps the IP flow carried in the DRB 641 to an IP flow 661. The UE 601 can then combine the two IP flows 661-662 to generate an IP flow 671. The IP flow 671 can then be transmitted to an XR application at the UE 601.

In some embodiments, the PDCP layer at the BS 602 can map one DRB to one RLC entity and one LCH. The packets (e.g., PDCP SDUs, PDCP PDUs) are classified into different classes (such as critical and non-critical packets) and processed with different priorities in the RLC entity or the MAC layer.

For the packet inspection and classification mechanisms disclosed herein, the packet inspection can be a two-stage operation. For example, a radio access layer (e.g., SDAP layer or PDCP layer) can first inspect a DSCP in an IP header of the IP layer to know if a respective packet belongs to an XR traffic. If the DSCP indicates the packet belongs to an XR traffic, then the radio access layer can further perform a deep packet inspection on one or more protocol headers of upper protocol layers (e.g., RTP header) to examine detailed attributes of the respective packet related with a particular XR application. If the DSCP indicates the packet does not belong to an XR traffic, the deep packet inspection can be skipped. XR-specific traffic handling may not be performed. This two-stage inspection can reduce the cost caused by deep packet inspection and thus improve the XR traffic handling efficiency.

Further, the packet inspection and classification mechanisms described with reference to FIG. 5 and FIG. 6 can also be applicable to uplink XR traffic handling. For example, the SDAP-based or PDCP-based packet inspection and classification mechanisms at the BS 502 or 602 for downlink traffic processing can also be applied in an SDAP layer or an PDCP layer at the UE 501 or 601 for uplink traffic processing. The SDAP layer or PDCP layer flow aggregation operations for classified packets (or data units) at the UE 501 or 601 for downlink traffic processing can be applied in an SDAP layer or a PDCP layer at the BS 502 or 602 for uplink traffic processing.

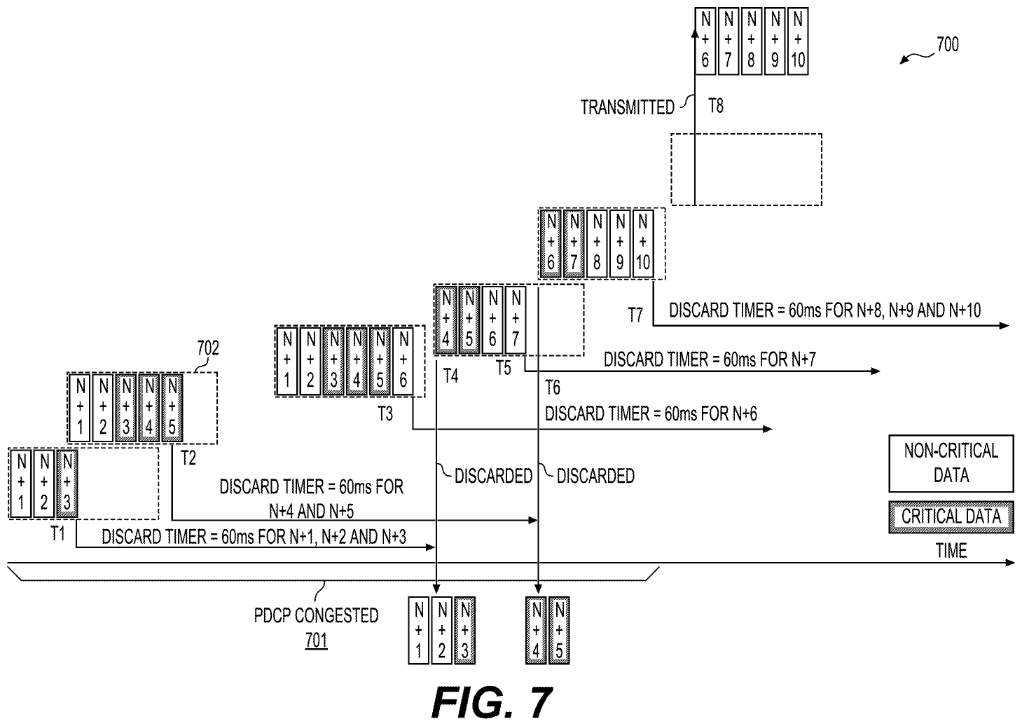

FIG. 7 shows a PDCP packet discarding process 700 based on a unified PDCP discard timer configuration. PDCP SDUs (or PDCP packets) labeled from N+1 to N+10 from a same DRB are received from upper protocol layers. The received packets are stored in a PDCP buffer 702. Packets N+1 and N+2 and packets from N+6 to N+10 are non-critical (normal) packets, while packets N+3, N+4, and N+5 are critical packets. Each PDCP SDU, when arriving, is assigned a discard timer having a same time interval (e.g., 60 ms). Thus, critical and non-critical (normal) PDCP SDUs are given the same time interval for the respective discard timers. The time interval can be assigned based on packet delay budget configured for the traffic carried in the DRB.

As shown, during a PDCP congestion period 701, packets N+1, N+2, and N+3 are assigned the discard timer at a time instant T1. Packets N+4 and N+5 are assigned the discard timer at a time instant T2. Packets N+6 and N+7 are each assigned the respective discard timer at T3 and T5. Packets from N+8 to N+10 are assigned the discard timer at T7. At T4, non-critical packets N+1 and N+2 and critical packets N+3 are discarded. At T6, critical packets N+4 and N+5 are discarded. At T8, a transmission opportunity is available, and non-critical packets from N+6 to N+10 are delivered. As shown, critical packets are treated equally as normal packets. As decoding of normal packets (e.g., corresponding to a P-frame) can depend on critical packets (e.g., corresponding to an I-frame), user quality of experience (QoE) will be impacted.

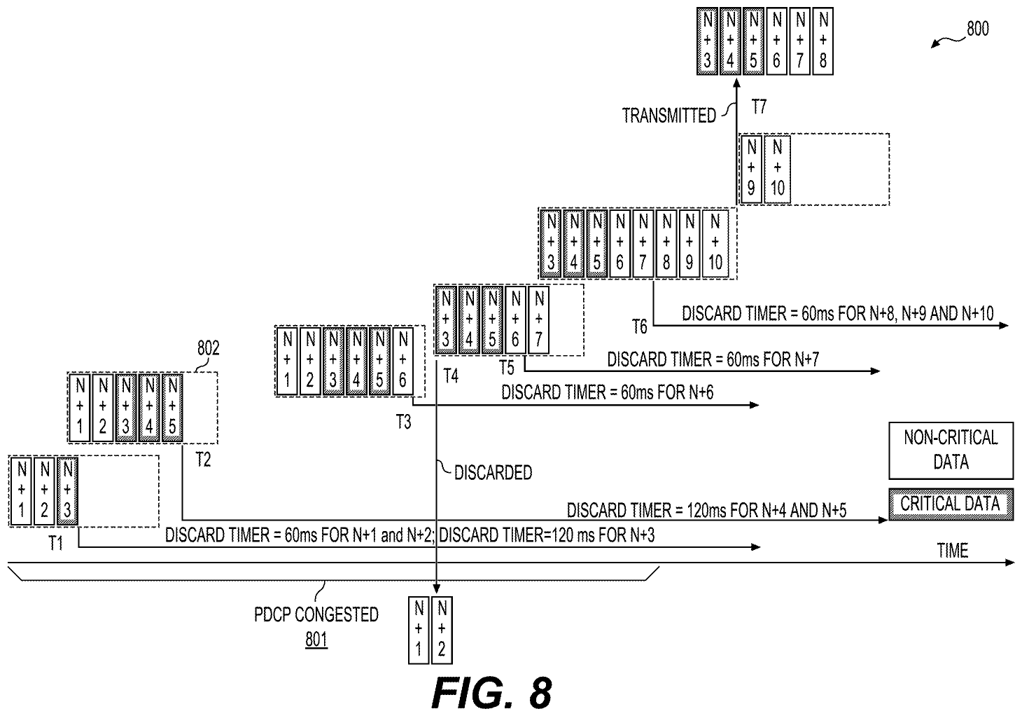

FIG. 8 shows a PDCP packet discarding process 800 according to embodiments of the disclosure. During the process 800, critical packets and normal (non-critical) packets at a PDCP layer are assigned timers with different time intervals based on packet inspection results. Critical packets are assigned with a longer discard timer than normal packets. Accordingly, critical packets can be kept longer than normal packets when PDCP congestion happens.

As shown, during a PDCP congestion period 801, PDCP SDUs (or PDCP packets) labeled from N+1 to N+10 from a same DRB are received from upper protocol layers. The received packets are stored in a PDCP buffer 802. Packets N+1 and N+2 and packets from N+6 to N+10 are non-critical (normal) packets and assigned a shorter discard timer of 60 ms. Packets N+3, N+4, and N+5 are critical packets and assigned a longer discard timer of 120 ms. Packets N+1, N+2, and N+3 are assigned the respective discard timers at a time instant T1. Packets N+4 and N+5 are assigned the discard timer at a time instant T2. Packets N+6 and N+7 are each assigned the respective discard timer at T3 and T5. Packets from N+8 to N+10 are assigned the discard timer at T6.

At T4, normal packets N+1 and N+2 are discarded when their 60 ms-timer expires. Different from the process 700, the critical packets from N+3 to N+5 are not discarded in process 800 because they have a longer timer of 120 ms. At T7, a transmission opportunity is available, the critical packets from N+3 to N+5 and normal packets from N+6 to N+8 are delivered to a lower layer. In this way, the receiver side may achieve a better decoding performance since more critical packets are available for decoding processing.

In some embodiments, the configurations of the different discard timers can be configured by radio resource control (RRC) signaling from a BS to a UE during the establishment of the DRB for XR traffic at the UE.

In the process 800, the PDCP layer assigns the discard timers based on knowledge of the packet characteristic of the XR packet when a PDCP SDU is received from an upper layer. There may be two alternatives for knowing the packet characteristics. One is that the PDCP layer itself inspects the packets (e.g., by looking at the IP header and/or the RTP header). The other alternative is that the upper layer (e.g., SDAP layer) can perform packet inspection and indicate the packet attribute to the PDCP layer when it delivers the packet to the PDCP layer. For example, interlayer signalling can be employed. In an embodiment, the packet attribute information can be carried in an SDAP header of an SDAP PDU.

Generally, different discard timer time interval values may be assigned to different types of the XR data packets with an aim to allow the more important packets to have more opportunity to be transmitted and to have less opportunity to be dropped. In addition, for the same type of XR data packets, different discard timer values may be assigned in some examples.

During the process 800, the packets belonging to a same ADU can be treated collectively. From an XR application perspective, XR video frames may be independent or dependent on other previous and/or future frames. Therefore, if an IP packet belonging to a particular ADU arrives too late, it may negatively affect previous ADUs, upcoming ADUs, as well as the play-out time of the current ADU. Thus, in some embodiments, all relevant PDCP packets that carry the IP packets belonging to an ADU (which may not be used for XR rendering) are dropped together. This can be beneficial from a capacity point of view. The media streaming transport layer (e.g., RTP) can be employed to provide ADU information for each member packet within a protocol header in order to help a radio layer protocol (e.g., PDCP) to get the ADU information for each packet.

In some embodiments, a set of coordinated PDCP discard timers is assigned to all the relevant PDCP packets that carry the IP packets belonging to an ADU (or other XR data packet unit that is used at the media stream transport layer). In some embodiments, a set of coordinated PDCP discard timers is assigned to all the relevant PDCP packets that carry the IP packets belonging to a particular XR frame (or other unit that is used at XR encoder). As a result, all the PDCP packets for an XR ADU or a XR frame (or another type of unit) can be discarded together.

To achieve coordinated PDCP packets dropping for these packets, in an embodiment, the PDCP may set the same discard timer for all of these packets (i.e. the packets belongs to the an ADU or a XR frame) and then start the timer at the same time. In an embodiment, the packets, received by PDCP layer from the upper layer not at the same time, can be assigned with a set of coordinated discard timer values in order to trigger group based coordinated PDCP packet dropping. For example, at time point T, the PDCP layer receives a PDCP SDU-1 for ADU-1 or XR frame-1, and the discard timer can be set with 60 ms. Then at time point T+10 ms, when the PDCP layer receives a PDCP SDU-2 for ADU-1 or XR frame-1, the discard timer can be set with 50 ms. In an embodiment, the PDCP layer records the XR ADU and XR frame that the PDCP SDU belongs to. In case of PDCP SDU discarding, the PDCP layer can discard all of the PDCP SDUs belonging to the same XR ADU and XR frame regardless of whether the discard timers expire or not.

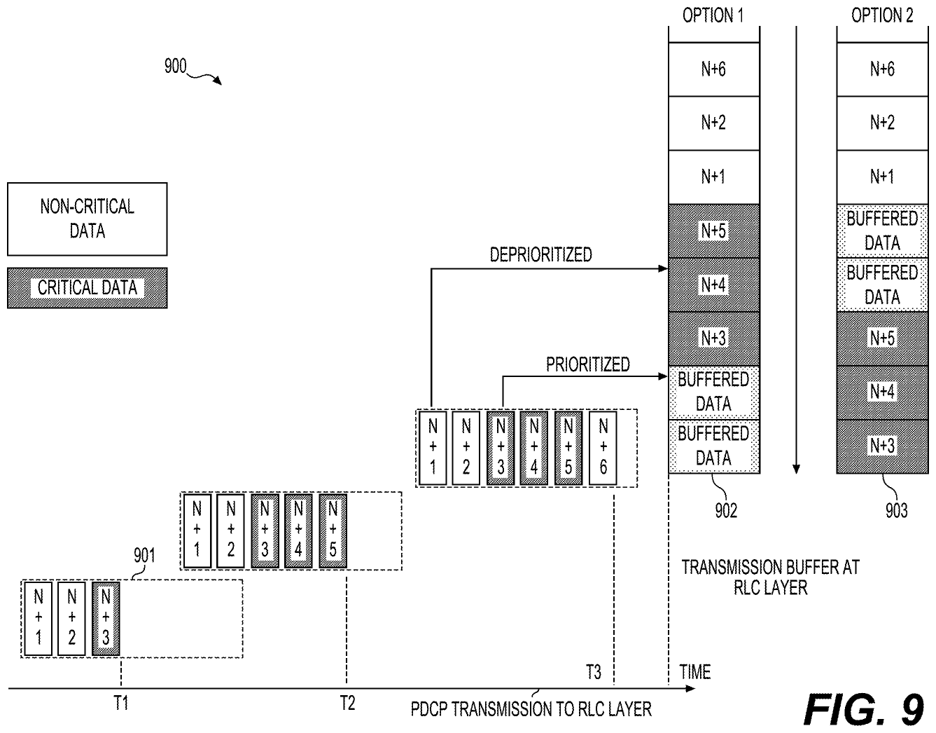

FIG. 9 shows a PDCP packet delivery process 900 according to embodiments of the disclosure. During the process 900, critical packets are prioritized over non-critical packets for packet delivery handling at a PDCP layer and an RLC layer. Six PDCP SDUs (PDCP packets) from N+1 to N+6 are received at the PDCP layer, for example, at a UE or a BS and stored in a PDCP buffer 901. Packets N+1, N+2, and N+3 are received at T1. Packets N+4 and N+5 are received at T2. Packet N+6 is received at T3. The packets are placed in the buffer 901 according to the timings of the packet arrivals. Based on a packet inspection at the PDCP layer or an indication from an upper layer, packets N+3, N+4, and N+5 are classified as critical packets, while packets N+1, N+2, and N+6 are classified as normal packets.

When delivering the packets from N+1 to N+6 to an RLC layer, the PDCP layer can prioritize the critical packets over the normal packets. As shown, critical packets N+3, N+4, and N+5 are first delivered and stored in an RLC buffer 902 followed by delivery of the normal packets N+1 and N+2.

Two options for packet handling at the RLC layer are shown. In the first option, packets (PDCP PDUs) received from the PDCP layer are placed in the buffer 902 according to the timing of arrivals. In a second option, as shown in a second RLC buffer 903, existing data (buffered data) in the buffer 903 is preempted by the critical packets N+3, N+4, and N+5 (PDCP PDUs) because the critical packets N+3, N+4, and N+5 has a higher priority than the existing data (which is normal packets). For implementing the second option, the RLC layer can perform packet inspection or receive an interlayer indication (interlayer signalling) from the upper PDCP layer on classes of the packets.

In some embodiments, corresponding to option 1 shown in FIG. 9, the RLC layer may ignore the positions of the packets and prioritize critical packets over normal packets for delivery to a MAC layer based on packet inspection and classification results or inter-layer signaling.

In some embodiments, at the PDCP layer, when new packets arrive, the PDCP layer may perform preemption process to insert critical packets in front of existing normal packets in the buffer 901. The preemption operation can be based on packet inspection and classification results or inter-layer signaling.

In some embodiments, a finer granularity buffer status report (BSR) may be supported to report critical data within an LCH. A new BS table may be used to reduce the quantization errors in BSR reporting (for example, for high data rate based XR traffic). For example, the BSR can indicate what amount of critical data is in a UE buffer and what amount of non-critical data is in the UE buffer. The BSR report can also indicate the remaining time to transmission or remaining packet delay budget, frame information (I-frame or P(B)-frame), and/or ADU information for the packets at the UE buffer to a BS (e.g., a gNB). For example, the UE can inform the BS the buffered packets belong to a critical frame and the remaining packet delay budget is 5 ms. For example, the UE can inform the BS distinguishing how much data is buffered which can help the BS to allocate physical resources for such scheduling in a timely manner.

In some embodiments, at a UE side, a MAC layer can indicate to a physical layer if there is any critical data assembled within a particular MAC PDU (i.e., Transport Block). The indication helps the physical layer to perform corresponding handling (e.g., disabling feedback-based hybrid automatic repeat request (HARM) retransmission for delay-sensitive packets).

In some embodiments, the packet classification and prioritization for XR packets at the PDCP/RLC/MAC layer in the FIG. 9 example can also be ADU-based packet handling, such as XR frame-based packet handling or packet handling based on other types of unit. For example, the PDCP SDUs that belong to the same XR ADU (or same XR fame) may be buffered together within the PDCP buffer although they may not be received at the same time. A late-coming PDCP SDU that belongs to a XR ADU or XR frame (with lots of PDCP SDU transmitted) can be prioritized by the PDCP layer for delivery to the RLC layer.

In some embodiments, the PDCP layer may ensure the PDCP packets that belong to the same XR ADU or XR frame be delivered to the RLC layer in a consecutive manner during packet prioritization and packet preemption. For example, if a PDCP packet that carries part of a critical XR frame is prioritized over a normal PDCP packet, all PDCP packets that carry that critical XR frame can be prioritized over the normal PDCP packet. The same principle can be applied to packet preemption.

In some embodiments, the packet prioritization and packet preemption at PDCP layer may be inherited by RLC layer for MAC PDU assembly. MAC layer may further notify the priority of a packet and/or other information to the physical layer to perform corresponding handling (e.g., disable feedback-based HARQ retransmission for delay-sensitive packets).

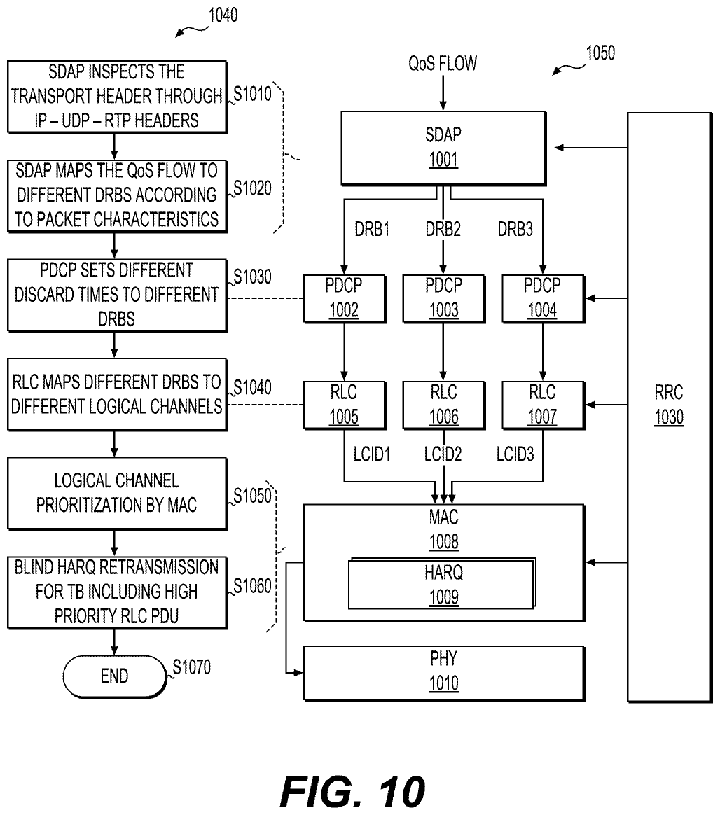

FIG. 10 shows an SDAP-based XR packet inspection and classification process 1040 according to embodiments of the disclosure. The process 1040 can be performed in a protocol stack 1050 of a radio access layer. The process 1040 includes steps from S1010 to S1070. During the process 1040, each layer in the protocol stack 1050 can receive configurations from an RRC layer 1030 and operate under the control of the RRC layer 1030.

At S1010, a QoS flow of XR traffic is delivered to an SDAP layer 1001. In one embodiment, the SDAP layer 1001 inspects the transport packet headers (e.g. IP/UDP/RTP) and knows the packet characteristics. At S1020, the SDAP layer 1001 maps the QoS flow to multiple DRBs to classify XR packets into critical packets and non-critical packets. The DRBs with different XR packets are transmitted to different PDCP entities 1002-1004. At S1030, in one embodiment, a PDCP layer configures different DRBs with different discard timers based on an RRC indication. PDCP PDUs (or PDCP SDUs) with critical XR packets will be discarded after a longer waiting time than those with non-critical XR packets. In one embodiment, the critical XR packets and non-critical XR packets may be mapped to different QoS flows. In one embodiment, different portions of the ADU or different ADUs of a particular XR traffic may be mapped to different QoS flows.

At S1040, in one embodiment, PDCP PDUs from different DRBs are mapped to different RLC entities 1005-1007 with different logical channels in an RLC layer. The logical channels are configured with different priorities. At S1050, RLC PDUs from different logical channels will then be prioritized and multiplexed to MAC PDUs at a MAC layer 1008. At S1060, in one embodiment, the MAC PDUs with critical packets will be distributed to a different HARQ entity 1009 for blind retransmission to enhance reliability in cooperation with a PHY 1010. The process 1040 can terminate at S1070.

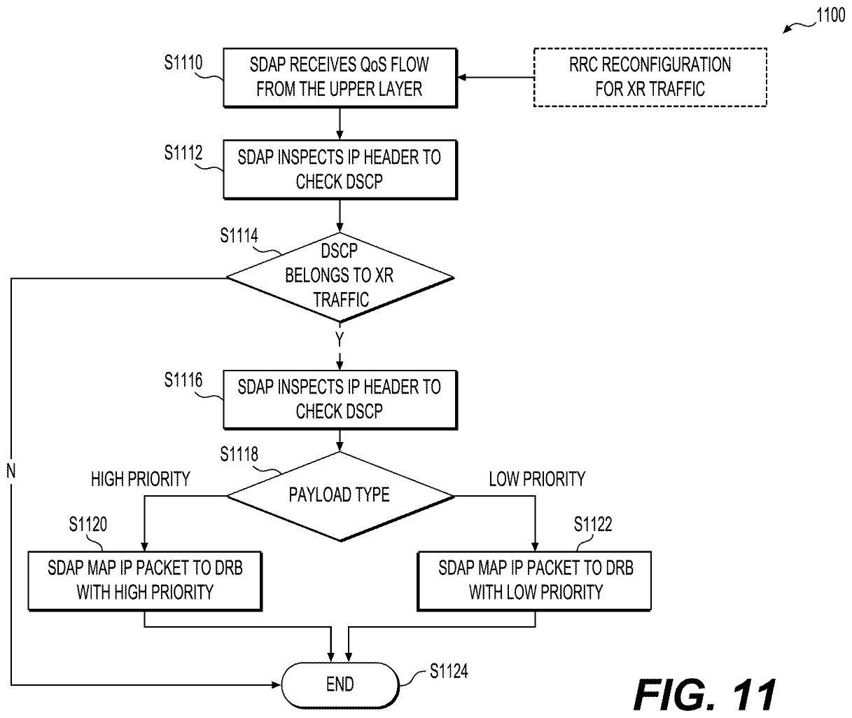

FIG. 11 shows an SDAP-based XR packet inspection and classification process 1100 according to embodiments of the disclosure. The process 1100 includes steps from S1110 to S1124.

At S1110, in one embodiment, an SDAP layer is reconfigured for XR traffic handling by RRC signaling. After receiving a QoS flow of XR traffic from an upper layer at S1110, the SDAP layer inspects the header of an IP packet to check the DSCP value at S1112. At S1114, the SDAP layer determines if the IP packet belongs to an XR traffic. IP packets with a DSCP value consistent with XR characteristics are regarded as XR traffic packets. When the IP packet belongs to an XR traffic, the process 1100 proceeds to S1116. Otherwise, the process 1100 proceeds to S1124.

At S1116, in one embodiment, the SDAP layer inspects UDP and/or RTP headers of XR packets to check the RTP payload type. At S1118, whether the payload type indicates a high-priority packet (critical packet) or a low-priority packet (non-critical packet) is determined for each packet. At S1120 and S1122, for packets associated with critical or non-critical video frames, the SDAP layer distributes the packets with different QoS requirements to DRBs with different priorities. Thereafter, an SDAP entity submits SDAP PDUs to lower layer after other packet handling procedures. The process 1100 terminates at S1124.

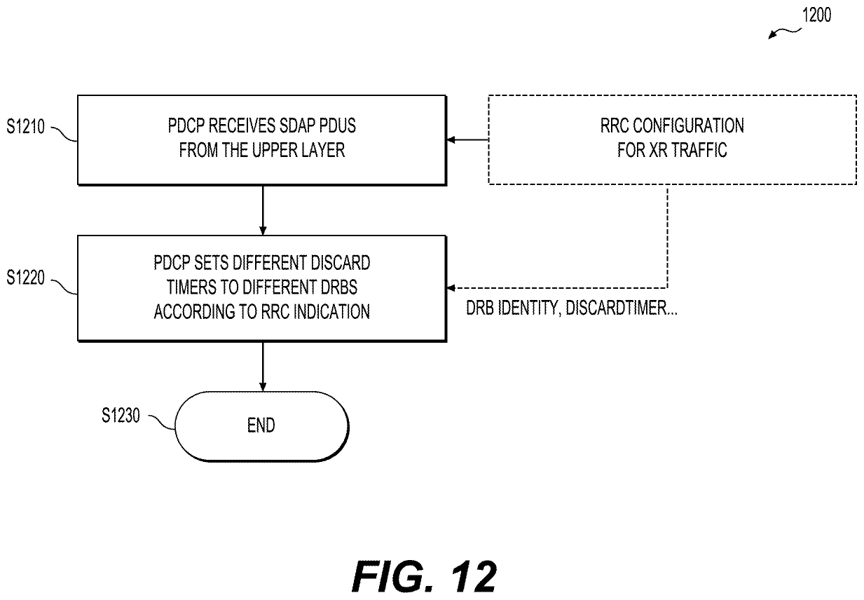

FIG. 12 shows a PDCP-layer XR traffic handling process 1200 according to embodiments of the disclosure. During the process 1200, a PDCP layer receives SDAP PDUs of an XR traffic and sets different discard timers to different DRBs based on an RRC indication. At 51210, in one embodiment, an SDAP entity associates two PDCP entities with different DRBs. After packet inspection and packet classification at the SDAP entity, the PDCP entities at the PDCP layer receive SDAP PDUs from the DRBs with different priorities.

At S1220, in one embodiment, the PDCP layer sets different discard timer values to different DRBs based on the RRC indication. The mapping rules between a DRB identity and a discard timer value is included in PDCP-Config information element and indicated to a UE through an RRC reconfiguration message. For a PDCP entity with higher-priority XR packets, the PDCP SDU is discarded after a longer waiting time for higher reliability compared with lower-priority XR packets. The PDCP entities submit PDCP PDUs to a lower layer after other packet handling procedures. The process 1200 terminates at S1230.

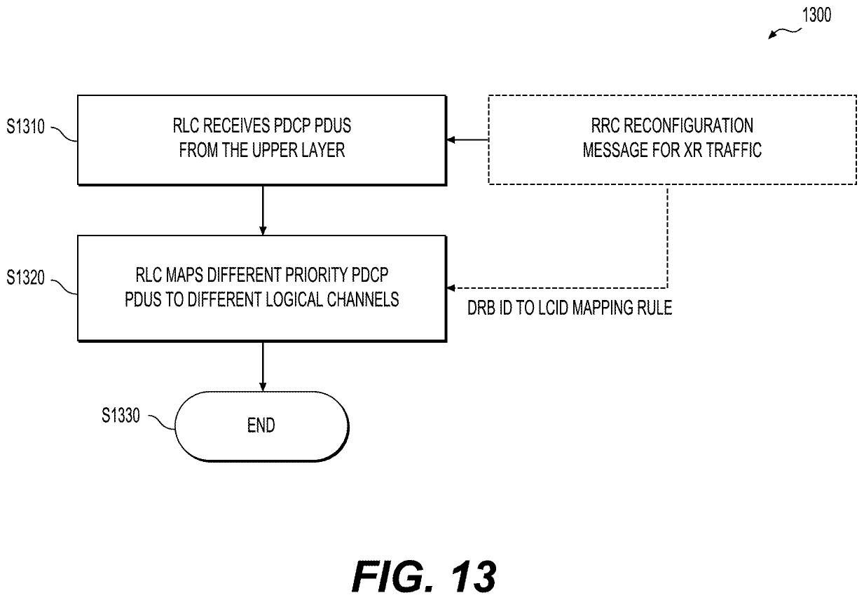

FIG. 13 shows an RLC-layer XR traffic handling process 1300 according to embodiments of the disclosure. During the process 1300, an RLC layer receives PDCP PDUs of an XR traffic from different DRBs and maps the PDCP PDUs to logical channels with different LCIDs based on an RRC indication.

At S1310, RLC entities at the RLC layer receive PDCP PDUs from PDCP entities with different DRB s. At S1320, the RLC entities map the PDCP PDUs to different logical channels. In one embodiment, each logical channel corresponds to an RLC entity. The mapping rules between DRBs and LCIDs are included in an RLC-BearerConfig information element and indicated to a UE through an RRC reconfiguration message. The RLC entities submit RLC PDUs to lower layer after other packet handling procedure. The process 1300 terminates at S1330.

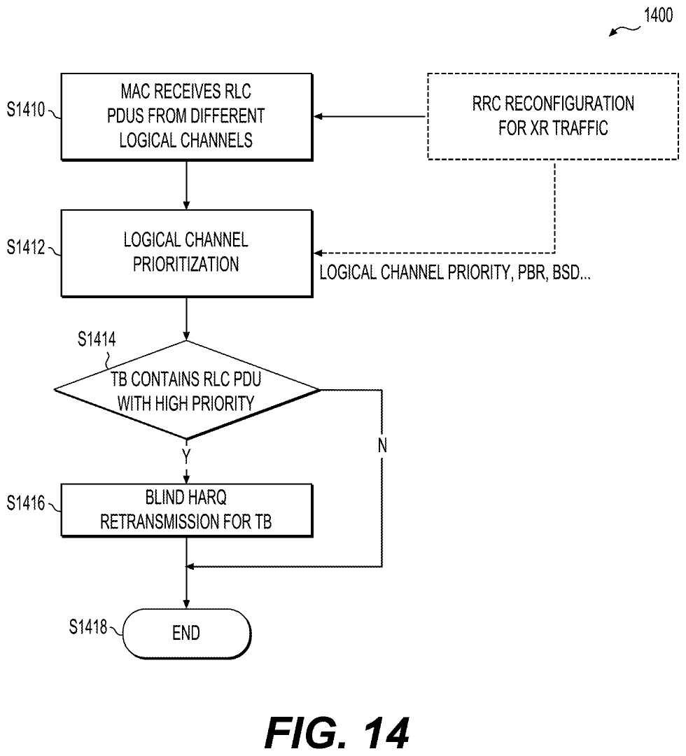

FIG. 14 shows a MAC-layer XR traffic handling process 1400 according to embodiments of the disclosure. During the process 1400, a MAC layer prioritizes RLC PDUs of an XR traffic among packets (data units) from different logical channels and multiplexes the RLC PDUs to MAC PDUs based on an RRC indication. In one embodiment, the MAC PDU with higher priority RLC SDUs will be processed with a blind HARQ retransmission.

At S1410, a MAC entity receives RLC PDUs from logical channels with different priorities. At S1412, logical channel priority and related parameters (e.g., prioritized bit rate (PBR), bucket size duration (BSD)) are included in a LogicalChannelConfig information element and indicated to a UE through an RRC reconfiguration message. A logical channel prioritization (LCP) procedure is applied, and XR packets are multiplexed to MAC PDUs.

In one embodiment, RLC PDUs with different priorities can be multiplexed to different MAC PDUs or the same MAC PDU. The MAC layer submits MAC PDUs to HARQ entities after multiplexing and assembly procedure. At S1414, whether a TB contains RLC PDU with a high priority is determined. TB s with different priority SDUs are delivered to different HARQ processes for HARQ operation. At S1416, for a TB with a higher-priority SDU, a blind HARQ retransmission is performed for reliability enhancement. MAC entity submits MAC PDUs to the lower layer after other packet handling procedures. The process 1400 terminates at S1418.

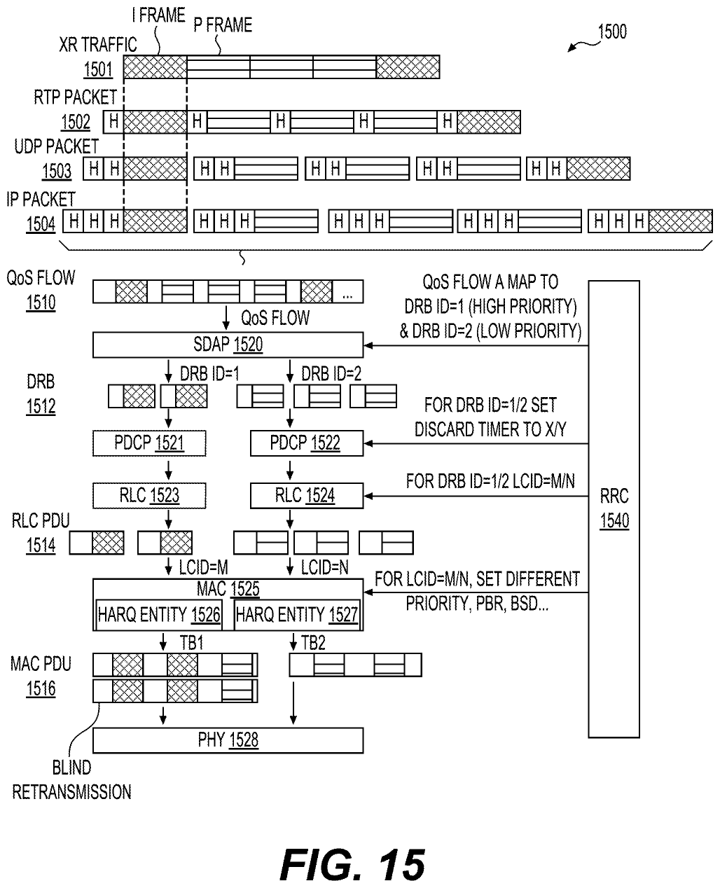

FIG. 15 shows an XR traffic handling process 1500 according to embodiments of the disclosure. The process 1500 can be performed at a protocol stack including Internet layers (e.g., RTP/UDP/IP) and a radio access layer. The process 1500 can be based on an SDAP-based packet inspection and classification mechanism.

In one embodiment, an XR traffic 1501 includes I-frames (representing critical frames) and P-frames (representing non-critical frames). Frame fragmentation is performed at a real-time transport layer (e.g., RTP). XR payload type and other information are put into the header of the transport layer. RTP packets 1502 are delivered to UDP/IP layer for packet forwarding. RTP packets 1502 are each encapsulated into a UDP packet 1503. The UDP packets 1503 are each encapsulated into an IP packet 1504. The type of service (XR traffic) is indicated by a DSCP in each IP header of the IP packet 1504.

In one embodiment, an SDAP layer 1520 receives a QoS flow 1510 of the XR traffic 1501 from the upper layer and inspects the header(s) of transport layer(s). For example, the SDAP layer 1520 can check DSCP at IP layer and/or RTP payload type at RTP layer. The SDAP 1520 distributes packets with different QoS requirements to DRBs 1512 with different priorities. In one embodiment, packets associated with I-frame are distributed to a DRB with DRB ID=1 (representing a high priority), and packets associated with P-frame are distributed to DRB with DRB ID=2 (representing a low priority). In one embodiment, the mapping rules between DRB IDs and priorities are indicated by RRC signaling at an RRC layer 1540.

After the SDAP packet handling, SDAP PDUs are submitted to a PDCP layer. In one embodiment, one SDAP entity is associated with two PDCP entities 1521-1522 to handle DRB s with different priorities. In one embodiment, the PDCP entities 1521-1522 set different discard timer values according to DRBs' priorities. PDCP SDUs with I-frame are set with a longer waiting time (discard timer value=X) before SDU discarding for achieving higher reliability. In one embodiment, the mapping rule between DRB IDs and timer values is indicated by RRC signaling.

After the PDCP packet handling, PDCP PDUs are submitted to an RLC layer. RLC entities 1523-1524 map PDCP PDUs from different DRBs to logical channels with different LCIDs. In one embodiment, the mapping rule between DRB IDs and LCIDs is indicated by RRC signaling. DRB ID=1 is map to LCID=M with higher reliability, and DRB ID=2 is mapped to LCID=N with lower reliability.

After the RLC packet handling procedure, RLC PDUs 1514 are submitted to a MAC layer 1525. A MAC entity multiplexes and assembles RLC PDUs from different logical channel (with different priorities) to MAC PDUs. In one embodiment, one MAC PDU only includes MAC SDUs of the same logical channel. For example, TB2 only includes MAC SDUs with P-frame of XR traffic from LCID=N. In one embodiment, one MAC PDU includes MAC SDUs of different logical channels. For example, TB1 includes MAC SDUs with both I-frame and P-frame of XR traffic from LCID=M and N. TB1 and TB2 correspond to different MAC PDUs 1516. In one embodiment, MAC SDUs with different priorities (for example, corresponding to different types of I-frames or P-frames) are not mapped to a same MAC PDU 1516.

After multiplexing and assembly procedure, MAC PDUs 1516 are delivered to different HARQ processes (operated by HARQ entities) 1526-1527 for HARQ operation. In one embodiment, blind HARQ retransmission is performed to MAC PDUs 1516 with a higher priority for reliability enhancement. For example, TB1, including MAC SDUs with I frame and P frame of the XR traffic 1501, is retransmitted before receiving any ACK/NACK feedback. After MAC packet handling procedure, MAC PDUs 1516 are submitted to a PHY layer 1528.

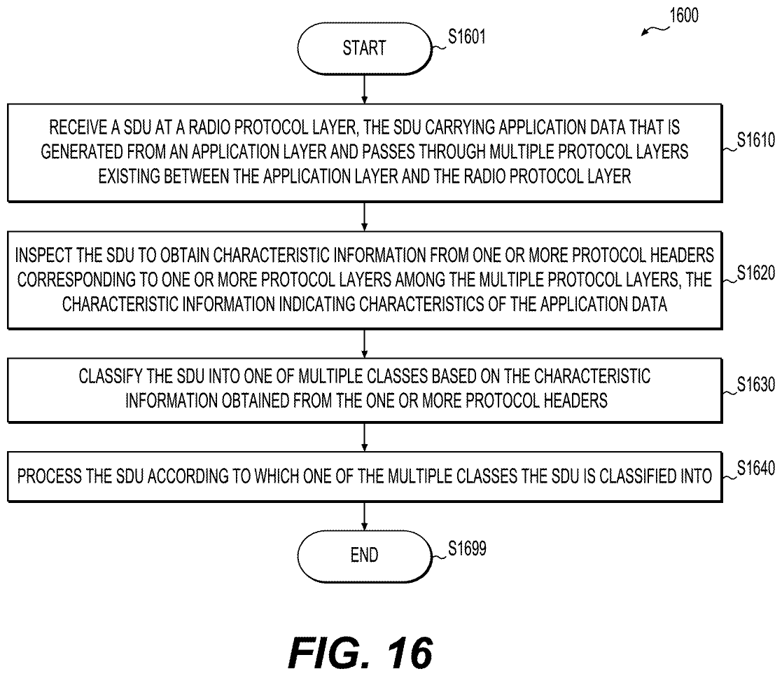

FIG. 16 shows a packet inspection and classification process 1600 according to embodiments of the disclosure. The process 1600 can be performed for handling traffic of a specific type of application, such as XR traffic. The process 1600 can be performed at a UE or a BS. In various embodiments, the steps in the process 1600 may be performed in a different order or in parallel. One or more steps may be skipped. Other steps may be added. The process 1600 starts from S1601 and proceed to S1610.

At S1610, an SDU can be received at a radio protocol layer in a RAN protocol stack. The SDU carries application data that is generated from an application layer and passes through multiple protocol layers existing between the application layer and the radio protocol layer. The radio protocol layer can be one of a SDAP layer, a PDCP layer, an RLC layer, a MAC layer, a PHY layer, and the like. The multiple protocol layers above the radio protocol layers can include an IP layer, a UDP layer, an RTP layer, and/or another radio protocol layer.

At S1620, the SDU can be inspected to obtain characteristic information from one or more protocol headers corresponding to one or more protocol layers among the multiple protocol layers. The characteristic information can indicate characteristics of the application data. In some embodiments, there can be a two-stage inspection process. In a first stage, an IP header in the SDU can be inspected to determine if the SDU is associated with a specific type of traffic, such as XR traffic. If so, a second-stage inspection can be performed to check a higher layer header, such as an RTP header to further obtain additional characteristic information.

At S1630, the SDU is classified into one of multiple classes based on the characteristic information obtained from the one or more protocol headers. For example, the classes can include a class of critical packets (critical data units) and a class of non-critical (normal) packets (non-critical data units).

At S1640, the SDU can be processed according to which one of the multiple classes the SDU is classified into. For example, at a SDAP layer, different classes of packets can be mapped to different DRBs and passed to different PDCP entities. For another example, at a PDCP layer, different classes of packets can be associated with discard timers with different time intervals. When delivery, critical packets can be prioritized over non-critical packets. In addition, packets belonging to a same ADU are processed collectively. For example, packets of a same ADU can be discarded together and delivered together. In an example, at a PDCP layer, packets from a same DRB but belonging to different classes are mapped to different RLC entities and LCHs. The process 1600 can terminates at S1699.

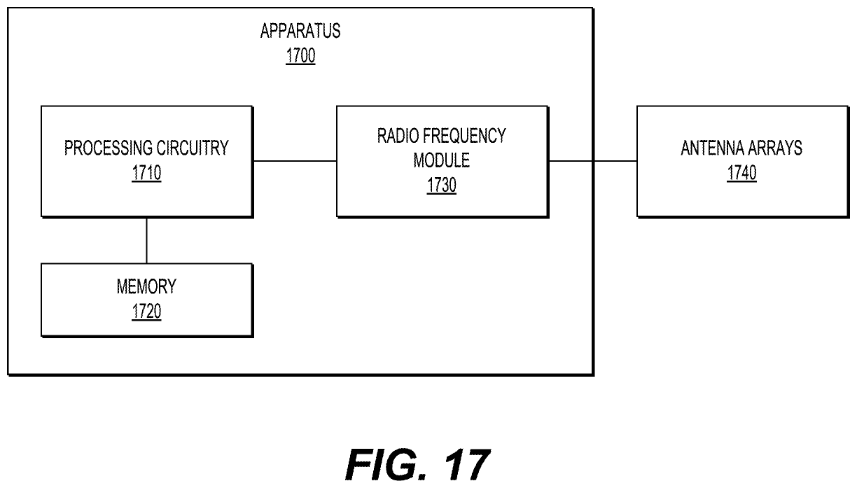

FIG. 17 shows an exemplary apparatus 1700 according to embodiments of the disclosure. The apparatus 1700 can be configured to perform various functions in accordance with one or more embodiments or examples described herein. Thus, the apparatus 1700 can provide means for implementation of mechanisms, techniques, processes, functions, components, systems described herein. For example, the apparatus 1700 can be used to implement functions of UEs, BSs, or UPFs in various embodiments and examples described herein. The apparatus 1700 can include a general-purpose processor or specially designed circuits to implement various functions, components, or processes described herein in various embodiments. The apparatus 1700 can include processing circuitry 1710, a memory 1720, and a radio frequency (RF) module 1730.

In various examples, the processing circuitry 1710 can include circuitry configured to perform the functions and processes described herein in combination with software or without software. In various examples, the processing circuitry 1710 can be a digital signal processor (DSP), an application-specific integrated circuit (ASIC), programmable logic devices (PLDs), field programmable gate arrays (FPGAs), digitally enhanced circuits, or comparable device or a combination thereof.

In some other examples, the processing circuitry 1710 can be a central processing unit (CPU) configured to execute program instructions to perform various functions and processes described herein. Accordingly, the memory 1720 can be configured to store program instructions. The processing circuitry 1710, when executing the program instructions, can perform the functions and processes. The memory 1720 can further store other programs or data, such as operating systems, application programs, and the like. The memory 1720 can include non-transitory storage media, such as a read-only memory (ROM), a random-access memory (RAM), a flash memory, a solid-state memory, a hard disk drive, an optical disk drive, and the like.

In an embodiment, the RF module 1730 receives a processed data signal from the processing circuitry 1710 and converts the data signal to beamforming wireless signals that are then transmitted via antenna arrays 1740, or vice versa. The RF module 1730 can include a digital-to-analog converter (DAC), an analog-to-digital converter (ADC), a frequency-up converter, a frequency-down converter, filters and amplifiers for reception and transmission operations. The RF module 1730 can include multi-antenna circuitry for beamforming operations. For example, the multi-antenna circuitry can include an uplink spatial filter circuit, and a downlink spatial filter circuit for shifting analog signal phases or scaling analog signal amplitudes. The antenna arrays 1740 can include one or more antenna arrays.

The apparatus 1700 can optionally include other components, such as input and output devices, additional or signal processing circuitry, and the like. Accordingly, the apparatus 1700 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random-access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving a service data unit (SDU) at a radio protocol layer in a radio access network (RAN) protocol stack, the SDU carrying application data that is generated from an application layer and passes through multiple protocol layers between the application layer and the radio protocol layer;
inspecting, at the radio protocol layer, the SDU to obtain characteristic information from one or more protocol headers corresponding to one or more protocol layers among the multiple protocol layers, the characteristic information indicating characteristics of the application data;
classifying, at the radio protocol layer, the SDU into one of multiple classes based on the characteristic information obtained from the one or more protocol headers; and
processing, at the radio protocol layer, the SDU according to which one of the multiple classes the SDU is classified into.

2. The method of claim 1, wherein the radio protocol layer is a service data adaption protocol (SDAP) layer in the RAN protocol stack, the SDU is an internet protocol (IP) packet, and the processing includes:
mapping the IP packet to a data radio bearer (DRB) according to which one of the multiple classes the IP packet is classified into, wherein IP packets belonging to different classes are mapped to different DRBs.

3. The method of claim 1, wherein the radio protocol layer is a packet data convergence protocol (PDCP) layer in the RAN protocol stack, the SDU is an PDCP SDU, and the processing includes:
mapping the PDCP SDU to a radio link control (RLC) entity according to which one of the multiple classes the PDCP SDU is classified into, wherein PDCP SDUs belonging to a same DRB but different classes are mapped to different RLC entities.

4. The method of claim 1, wherein the radio protocol layer is a PDCP layer in the RAN protocol stack, the SDU is an PDCP SDU, and the processing includes:
assigning to the PDCP SDU a PDCP discard timer having a time interval determined according to which one of the multiple classes the PDCP SDU is classified into, wherein PDCP SDUs belonging to different classes are assigned with PDCP discard timers having different time intervals.

5. The method of claim 4, wherein PDCP SDUs that are associated with a same application data unit (ADU) are discarded together.

6. The method of claim 4, wherein PDCP SDUs that are associated with a same application data unit (ADU) are associated with a same discard timer.

7. The method of claim 1, wherein the radio protocol layer is a PDCP layer in the RAN protocol stack, the SDU is a first PDCP SDU, and the processing includes:
prioritizing delivery of the first PDCP SDU of the one of the multiple classes over a second PDCP SDU, the second PDCP SDU being classified into a class having a lower priority than the one of the multiple classes.

8. The method of claim 1, wherein the radio protocol layer is an RLC layer in the RAN protocol stack, the SDU is a first RLC SDU, and the processing includes:
prioritizing delivery of the first RLC SDU of the one of the multiple classes over a second RLC SDU, the second RLC SDU being classified into a class having a lower priority than the one of the multiple classes.

9. The method of claim 1, wherein the classifying includes:
classifying the SDU into a first class when the characteristic information obtained from the one or more protocol headers indicates the SDU is associated with an I-frame in a video sequence; and
classifying the SDU into a second class when the characteristic information obtained from the one or more protocol headers indicates the SDU is associated with a P frame or a B frame in the video sequence, the first class having a higher priority than the second class.

10. The method of claim 1, wherein the multiple protocol layers include an IP layer and a real-time transport protocol (RTP) layer, and the inspecting includes:
inspecting, at the radio protocol layer, an IP header of the IP layer in the SDU to obtain first characteristic information; and
when the first characteristic information indicates the SDU is associated with a specific type of traffic, proceeding to inspect an RTP header of the RTP layer to obtain second characteristic information.

11. The method of claim 10, wherein the first characteristic information is indicated by a differentiated services code point (DSCP) in the IP header, and the second characteristic information is indicated by an RTP payload type value in the RTP header.

12. An apparatus, comprising circuitry configured to:
receive a service data unit (SDU) at a radio protocol layer in a radio access network (RAN) protocol stack, the SDU carrying application data that is generated from an application layer and passes through multiple protocol layers existing between the application layer and the radio protocol layer;
inspect, at the radio protocol layer, the SDU to obtain characteristic information from one or more protocol headers corresponding to one or more protocol layers among the multiple protocol layers, the characteristic information indicating characteristics of the application data;
classify, at the radio protocol layer, the SDU into one of multiple classes based on the characteristic information obtained from the one or more protocol headers; and
process, at the radio protocol layer, the SDU according to which one of the multiple classes the SDU is classified into.

13. A non-transitory computer-readable medium storing instruction that, when executed by a processor, cause a processor to perform a method, the method comprising:
receiving a service data unit (SDU) at a radio protocol layer in a radio access network (RAN) protocol stack, the SDU carrying application data that is generated from an application layer and passes through multiple protocol layers existing between the application layer and the radio protocol layer;
inspecting, at the radio protocol layer, the SDU to obtain characteristic information from one or more protocol headers corresponding to one or more protocol layers among the multiple protocol layers, the characteristic information indicating characteristics of the application data;
classifying, at the radio protocol layer, the SDU into one of multiple classes based on the characteristic information obtained from the one or more protocol headers; and
processing, at the radio protocol layer, the SDU according to which one of the multiple classes the SDU is classified into.

14. The non-transitory computer-readable medium of claim 13, wherein the radio protocol layer is a service data adaption protocol (SDAP) layer in the RAN protocol stack, the SDU is an internet protocol (IP) packet, and the processing includes:
mapping the IP packet to a data radio bearer (DRB) according to which one of the multiple classes the IP packet is classified into, wherein IP packets belonging to different classes are mapped to different DRBs.

15. The non-transitory computer-readable medium of claim 13, wherein the radio protocol layer is a packet data convergence protocol (PDCP) layer in the RAN protocol stack, the SDU is an PDCP SDU, and the processing includes:
mapping the PDCP SDU to a radio link control (RLC) entity according to which one of the multiple classes the PDCP SDU is classified into, wherein PDCP SDUs belonging to a same DRB but different classes are mapped to different RLC entities.

16. The non-transitory computer-readable medium of claim 13, wherein the radio protocol layer is a PDCP layer in the RAN protocol stack, the SDU is an PDCP SDU, and the processing includes:
assigning to the PDCP SDU a PDCP discard timer having a time interval determined according to which one of the multiple classes the PDCP SDU is classified into, wherein PDCP SDUs belonging to different classes are assigned with PDCP discard timers having different time intervals.

17. The non-transitory computer-readable medium of claim 16, wherein PDCP SDUs that are associated with a same application data unit (ADU) are discarded together.

18. The non-transitory computer-readable medium of claim 16, wherein PDCP SDUs that are associated with a same application data unit (ADU) are associated with a same discard timer.

19. The non-transitory computer-readable medium of claim 13, wherein the radio protocol layer is a PDCP layer in the RAN protocol stack, the SDU is a first PDCP SDU, and the processing includes:
prioritizing delivery of the first PDCP SDU of the one of the multiple classes over a second PDCP SDU, the second PDCP SDU being classified into a class having a lower priority than the one of the multiple classes.

20. The non-transitory computer-readable medium of claim 13, wherein the radio protocol layer is an RLC layer in the RAN protocol stack, the SDU is a first RLC SDU, and the processing includes:
prioritizing delivery of the first RLC SDU of the one of the multiple classes over a second RLC SDU, the second RLC SDU being classified into a class having a lower priority than the one of the multiple classes.
